(19) United States
(12) Patent Application Publication
(10) Pub. No.: US 2026/0159430 A1
(43) Pub. Date: Jun. 11, 2026

(54) METHOD OF PREPARING A MELT FOR THE PRODUCTION OF MAN-MADE MINERAL FIBRES

(71) Applicant: ROCKWOOL A/S, Hedehusene (DK)

(72) Inventors: Lars Elmekilde HANSEN, Hedehusene (DK); Haosheng ZHOU, Hedehusene (DK)

(21) Appl. No.: 18/707,467

(22) PCT Filed: Nov. 4, 2022
(86) PCT No.: PCT/EP2022/080868

§ 371 Date: May 3, 2024

(30) Foreign Application Priority Data
Nov. 5, 2021 (EP) 21206795.3

(51) Int. Cl. C03B 5/02; C03B 37/04; C03C 1/00; C03C 13/06; F27B 1/08; F27D 11/00; F27D 99/00

(52) U.S. Cl. CPC C03B 5/025; C03C 1/002; C03C 13/06; F27B 1/08; F27D 11/00; C03B 37/04; F27D 2099/0031; F27M 2001/07

(57) ABSTRACT

The invention relates to a process for preparing a mineral melt in a cupola furnace that comprises, in the hot zone where the melt collects, a plurality of ceramic support bodies, with at least one plasma torch providing heat energy to the furnace. The combination of the plasma torch and ceramic support bodies reduces or substantially eliminates the need for coke to be used in the furnace. This reduces the formation of environmentally harmful gasses, such as CO and CO₂, in the off-gas of the furnace.

### FIELD OF INVENTION

The invention relates to a process for preparing a mineral melt in a cupola furnace that comprises, in the hot zone where the melt collects, a plurality of ceramic support bodies, with at least one plasma torch providing heat energy to the furnace. The combination of the plasma torch and ceramic support bodies reduces or substantially eliminates the need for coke to be used in the furnace. This reduces the formation of environmentally harmful gasses, such as CO and CO₂, in the off-gas of the furnace.

### BACKGROUND

Methods of preparing a mineral melt for the production of man-made vitreous fibres (MMVF) are known to be carried out in shaft furnaces, such as cupola furnaces. They involve heating mineral material in the presence of coke and an oxygen-containing gas to form the mineral melt. The use of coke as a means of providing heat in the furnace, and as a reducing agent, produces a significant amount of CO and CO₂, which have a negative effect on the environment. In view of the roles that coke plays in the formation of mineral melts, it is challenging to efficiently produce melts in a cupola furnace that has reduced or substantially eliminated the production of CO and CO₂.

Coke is also used to support the stack of mineral material (the raw material used to form the mineral melt) in a cupola furnace. Without that coke support, unmelted mineral material will be found in the melt that has collected, or pooled, at the bottom of the hot zone, and will contaminate the mineral melt that is removed from the furnace.

Cupola furnaces typically comprise a range of temperature zones, including a hot zone, an oxidation zone, a reduction zone, and a preheating zone.

The lower portion of the cupola furnace constitutes the hot zone. The hot zone comprises the mineral melt formed in the cupola, which mineral melt is typically located in the space between the pieces of coke that are resting on the bottom of the furnace, and which support the material above. In typical cupola furnaces, the melt temperature in the hot zone is in the range of 1450° C. to 1550° C., and it takes a relatively long time to change the temperature of a mineral melt at this location. Further, the distance between the top and bottom of the hot zone is relatively large. This is needed to ensure that the correct oxidation zone temperature is maintained in traditional cupola furnaces.

The oxidation zone (also known as the combustion zone) is typically present above the hot zone. The lower portion of the oxidation zone is usually provided with gas inlet nozzles, known as tuyeres, through which preheated air or another oxygen-containing gas is introduced into the furnace. Heating is usually generated by combustion of coke. Coke combustion, along with combustion of other forms of carbon that may be present in the mineral material, such as oils and binders contained in recycled material, contribute to the production of CO₂ in the furnace.

The combustion of the coke, and the other sources of carbon, takes place during the movement of the preheated air up through the oxidation zone, and the gas temperature may rise from about 500° C. to about 2,000° C., thus causing mineral material that moves down through the oxidation zone to be heated to its melting point. This melted mineral material flows down into the hot zone at the base or bottom of the cupola furnace. The vertical extension of the oxidation zone is determined by the amount of oxygen introduced into the furnace.

The reduction zone is above the oxidation zone, and starts at the level where the oxygen introduced through the tuyeres is consumed by combustion of the coke. In the reduction zone, where the temperature is typically between 1,000° C. and 1,500° C., coke reacts with the CO₂ formed in the oxidation zone to form CO in an amount which is double the amount of consumed CO₂ based on volume.

This reaction is endothermic causing about 20-25% of the energy released by the combustion in the oxidation zone to be lost as latent heat in the off-gas. As is typical, the off-gas may be used to heat the mineral materials due to be melted in the cupola furnace in the preheating zone. The preheating zone is above the reduction zone.

U.S. Pat. No. 4,556,418 relates to process for forming molten iron from scrap iron, scrap steel, pig iron, direct reduced iron or mixtures thereof using enriched air as a primary oxidant. Heat energy used to form the molten iron is derived from natural gas, fuel oil, or pulverised coal. A bath of molten metal is produced in the lower portion of a furnace. To prevent the molten bath from being cooled by unmelted portions of ferrous material, ceramic pieces may be located in the furnace shaft, for instance on shoulders located around the inside circumference of the shaft furnace, above the lower portion of a furnace and the molten metal bath. Molten metal may be tapped from the bath via a siphon. The ceramic pieces are not located in the molten bath.

U.S. Pat. No. 5,107,517 relates to a process for forming a mineral melt for mineral wool production, using a melting furnace comprising a water-cooled grate disposed above a combustion chamber, on which is located a bed of ceramic filling bodies as well as raw materials. The bottom portion of the combination chamber collects the melt that drips from the shaft. The problem with this design is that water must flow though the grate when the furnace is in use to prevent damage to the grate by the high temperature environment within the furnace. The heat is provided to the combustion chamber using conventional gas (natural or liquified) or a liquid fuel like oil. Additional electrical energy may be used to heat the furnace, however, this is limited to a maximum of 20% of the total energy required. The melt may be collected via a siphon that is disposed at a certain height above the bottom of the combustion chamber, and below the level of the water cooled grate.

JPH 10141629 relates to a method and apparatus for treating waste by burning and thermally decomposing industrial waste and municipal waste using a vertical melting furnace. Such waste includes woody waste made of paper or wood chips, raw garbage, metal waste from scrapped automobiles and the like, non-combustible waste such as glass products and porcelain products, and waste plastic products. As with U.S. Pat. No. 5,107,517, the furnace requires the use of water-cooled tubes above the combustion chamber, and on which sit refractory bodies. Heat is provided to the furnace using conventional gas burners (with no mention of electric or plasma heating) in the area below the water-cooled tubes, after which it travels up through the waste material. This arrangement is designed to only allow melted material to pass the water-cooled tubes and drip into the combustion chamber.

One of the problems with the furnace described in U.S. Pat. No. 5,107,517 and JPH 10141629 is that standard cupola furnaces for preparing a mineral melt need to be modified to accommodate the water-cooled tubes and cooling system. The tubes will also degrade over time and need replacing which increases maintenance costs and downtime of the furnace.

EP 2 284 130 relates to the production of mineral wool from a mineral melt produced in a cupola furnace. The furnace comprises a grate, disposed above the combustion chamber, to prevent the mineral material from entering combustion chamber. The melt is formed using heat generated using a liquid or gas-fuel burner. An outlet to remove the melt from the furnace is located in the combustion chamber.

WO 2019/201182 relates to cast iron smelting equipment in which heat is provided by a plasma torch. Within the furnace the mineral material is supported on high carbon spheres that are heated by the plasma. Due to the composition of the spheres and the conditions within the heating plasma, the high carbon spheres will undergo significant degradation during use, and will need to be replaced by addition of further high carbon spheres together with additional raw material. The carbon contained within the spheres may also contribute to formation of CO and CO₂ in the furnace off-gas.

Coke serves multiple roles in the formation of a mineral melt. Finding processes that reduce, or substantially eliminate, the processes' reliance on coke remains a challenge, despite the advantages, both environmental and economic, for doing so.

There is therefore a need for more efficient, environmentally-friendly cupola furnaces that are suitable for forming mineral melts, such as those used to produce MMVF, e.g. glass fibre or stone fibre. It is desirable that the amount of coke and/or other sources of carbon present in the furnace is reduced or substantially eliminated, as this leads to a reduction in the production of harmful CO and CO₂. There is also a need for a more efficient way of superheating a mineral melt in a cupola furnace.

This need is met by using a plasma torch to heat mineral materials (i.e. the raw materials used to form a mineral melt), in combination with a plurality of ceramic support bodies located in a section of the hot zone in which the mineral melt collects prior to it being removed from the furnace.

### FIGURES

FIG. 1 shows a schematic representation of a cupola furnace configuration that may be used to implement the invention.

### SUMMARY

In a first aspect of the invention, there is provided a process for preparing a mineral melt in a cupola furnace, wherein the cupola furnace comprises a hot zone at the base of the furnace, and a melt outlet, preferably a melt siphon, in the hot zone,
(i) the furnace comprises at least one plasma torch that provides plasma heating in the hot zone;
(ii) greater than 50% of the furnace heating energy is provided by the at least one plasma torch;
(iii) the furnace comprises a plurality of ceramic support bodies located in a section of the hot zone in which the mineral melt collects prior to the mineral melt being removed from the furnace through the melt outlet, wherein mineral material supplied to the furnace is melted to form the mineral melt that collects in voids between the ceramic supports bodies.

In a second aspect of the invention, there is provided a process for manufacturing MMVF comprising the steps of
(i) forming a melt using a process as defined in the first aspect of the invention;
(ii) fiberizing the melt by means of an internal or external spinning process; preferably using a cascade spinner; and
(iii) collecting the formed fibres.

### DETAILED DESCRIPTION OF THE INVENTION

The advantages of the present invention may be achieved by the use of a furnace comprising a plurality of ceramic support bodies located in a section of the hot zone in which the mineral melt collects prior to the mineral melt being removed from the furnace, with at least one plasma torch providing plasma heating in the hot zone. This means that the amount of coke used in the process may be reduced, or substantially eliminated, leading to the production of less CO and CO₂.

The ceramic support bodies are located in a section of the hot zone in which the mineral melt collects, or pools, prior to the mineral melt being removed from the furnace through the melt outlet, which is preferably a melt siphon. Ideally, the ceramic support bodies are sat on the inside base of the furnace, however they may also be suspended above the inside base. Importantly, the ceramic support bodies should be located in the furnace such that mineral melt, once formed, collects (or pools) in the voids between the ceramic support bodies prior to its removal. This is a key difference to the furnaces in U.S. Pat. No. 5,107,517 and JPH 10141629 in which mineral melt drips past ceramic filling bodies/refractory bodies and collects at the base of the furnace, i.e. mineral melt does not collect in the voids between the ceramic filling bodies/refractory bodies prior to its removal from the furnace.

The location of the ceramic support bodies in the furnace should also prevent a substantial portion of the mineral material from contacting the collected or pooled mineral melt. In this regard, the ceramic support bodies may be used to separate mineral melt from raw materials, prior to removal of the melt from the furnace, such as through a melt outlet, preferably a melt siphon. In traditional cupola furnaces used to make mineral melt, this may be achieved using coke. However, in this case, it has been found that this is an efficient way to filter a mineral melt in a process that does not use coke.

It has also been found that the ceramic support bodies may increase thermal efficiency when superheating a mineral melt, such as one suitable for the manufacture of MMVF. It is important to deliver a mineral melt to the next process stage, such as to a spinner used to form MMVF, at the correct temperature. Once removed from a furnace, a mineral melt will begin to cool, therefore, the mineral melt may be superheated prior to it being removed from a furnace to compensate for such cooling. Traditional ways of superheating a mineral melt have low efficiency, particularly when coke is present in the pooled mineral melt to support the stack of mineral material. The combination of plasma heating and ceramic support bodies as per the present invention provides more efficient superheating to the pooled mineral melt. Without wishing to be bound by theory, this may be because the combination of plasma heating and ceramic support bodies means that a lower amount of CO may be produced in the furnace. Reduction of the amount of CO in the off-gas may increase thermal efficiency of the furnace, which in turn means more efficient superheating of the pooled mineral melt.

The support bodies may be made from any suitable ceramic-type material that is able to withstand the conditions experienced within a furnace. It is understood that many ceramic-type materials may be suitable for use in the present invention despite them degrading over time when used in a furnace. The degradation may be thermal, chemical or physical. Typically, the degradation is by melting and/or by reacting with mineral material used to form the mineral melt. In view of this, it is preferable that the ceramic support bodies have a high melting temperature, and/or high resistance to chemical and/or physical degradation. This increases the durability of the ceramic support bodies, so that they will not need to be replaced as frequently.

Accordingly, it is preferable that the ceramic support bodies have a melting temperature of at least 1,400° C., preferably at least 1,600° C., more preferably at least 1,800° C. It is understood that ceramic support bodies having a higher melting temperature should degrade at a slower rate at the temperatures experienced in the hot zone of the furnace.

It is also preferable that the ceramic support bodies are resistant to chemical degradation in the cupola furnace during the formation of mineral melt. Chemical degradation may occur by reaction of the ceramic support bodies with the mineral material used to form the mineral melt.

The ceramic support bodies should also be resistant to physical degradation. This means that they should not lose their structural integrity due to the force applied to them, such as the weight of the stack of mineral material, in the furnace at operating temperatures.

The skilled person will understand the scope of the term “ceramic” within its present use. Ceramics are often crystalline, although they also may contain a combination of glassy and crystalline phases. Suitable ceramics that may be used to form the support bodies typically comprise a metal oxide, or more preferably a combination of metal oxides. Suitable metal oxides include, but are not limited to, Al₂O₃, FeO, Fe₂O₃, SiC₂, Cr₂O₃, ZrO₂, MgO, and combinations thereof. The properties of the ceramic may be tuned by using different ratios of metal oxides. Particularly useful ceramic support bodies include those that comprise a combination of AI₂O₃, Fe₂O₃, SiC₂, and Cr₂O₃, or AI₂O₃, SiC₂, Na₂O and ZrO₂. In those cases, it is preferable the Cr₂O₃ or ZrO₂ is present in a ceramic support body in an amount of at least 5 weight % based upon the total weight of a ceramic support body. Suitable ceramic support bodies that comprise Cr₂O₃ include those sold under the name Durital, such as Durital RK10 and RK50 (comprising 10 and 50 weight % of Cr₂O₃, respectively). Suitable ceramic support bodies that comprise ZrO₂ include those sold under the name SCIMOS Z. Typical compositions for those materials are outlined in the tables below.

| Name | Al₂O₃ | Fe₂O₃ | SiO₂ | Cr₂O₃ | Other |
|---|---|---|---|---|---|
| Durital RK10 | 85.0 | 0.6 | 0.8 | 10.5 | 3.1 |

| Name | Al₂O₃ | SiO₂ | Na₂O | ZrO₂ | Other |
|---|---|---|---|---|---|
| SCIMOS Z | 0.6 | 4.4 | 0.3 | 94.0 | 0.7 |

The ceramic support bodies may be formed from the material used to make the lining of the furnace, which has been designed to withstand furnace conditions. These are commonly referred to as firebrick or refractory bricks, and include bricks made from the ceramic materials described above.

As mentioned, the ceramic support bodies may degrade over time when used in a furnace. Due to such decomposition, components of the ceramic support bodies may be present in the mineral melt that is removed from the furnace. The skilled person would be able to account for the presence of ceramic support body components in the final composition of the mineral melt.

The ceramic support bodies may be of any shape that enables them to provide the above-mentioned advantages. For instance, when stacked at the bottom of the furnace, their shape should create voids between individual ceramic support bodies, preferably without the need to prearrange their configuration to do so. It is also advantageous to reduce the surface to volume ratio of the ceramic support bodies, as their degradation tends to occur at their surface. It is not necessary to be able to express the shape of the ceramic support bodies in geometric terms. In fact, they may have an irregular shape. However, their general shape may be described as cylinders, discs, rods or ball-shaped. In this regard, it is preferable that the cylinders have a length that is 0.3 to 3 times (preferably 0.5 to 2 times) their diameter. Rods generally have a much longer length than their diameter, whereas discs generally have a much shorter length than their diameter. Those shapes provide suitable surface to volume ratios to reduce the rate of degradation. However, it is preferable that the ceramic support bodies are cylinder or ball-shaped as this helps to lower the surface to volume ratio. Cylinders have the advantage that they may be easier to manufacture, whereas ball-shaped ceramic support bodies have a more favourable surface to volume ratio meaning that their rate of degradation in the furnace may be slower. The ceramic support bodies may have a surface to volume ratio of from 0.07 to 0.21, preferably 0.08 to 0.15, more preferably 0.09 to 0.13, most preferably 0.10 to 0.11.

It is preferable that the shape of the ceramic support bodies is expressed as its “equivalent spherical diameter”. This is the diameter of a sphere of equal volume, and may be calculated for any three-dimensional shape, such as cylinders, rods and oblate and prolate spheroids. It may be calculated by measuring the volume of a body, and calculating the diameter of a sphere that has the equivalent volume using the equation

$$d = \sqrt[3]{\frac{6 V}{π}}$$

$$wherein d = diameter ( mm )$$

$$V = volume ( {mm}^{3} )$$

The volume of a body may be measured using a water displacement method. In this method, the body is submerged in water and the volume of water that is displaced in the process is measured, such as by using an Eureka cup or similar vessel.

It may be advantageous for the ceramic support bodies to have an equivalent spherical diameter of from 60 mm to 250 mm, preferably from 70 mm to 200 mm, more preferably from 80 mm to 150 mm, most preferably from 90 mm to 110 mm. Ceramic support bodies of those equivalent spherical diameters would be suitable for use in typical furnace melt baths. Ideally, the equivalent spherical diameter should be less than the depth of the melt bath, so that multiple layers, such as two or more layers (preferably 2 or 3 layers), of ceramic support bodies are used to prevent the stack of mineral material from being partially submerged in the mineral melt. The depth of the melt bath may be measured from the inside base of the furnace to the surface of the mineral melt during the process. In practice, the ceramic support bodies may not be present in the furnace in an organised arrangement forming defined layers. Instead, they may be in a random arrangement. Therefore, “multiple layers” essentially means that the total height of the ceramic support bodies in the furnace is greater than their equivalent spherical diameter. In addition, the total height of the ceramic support bodies should be above the level of the mineral melt outlet. When the outlet is a siphon, the total height of the ceramic support bodies should be above the level of the inlet to the siphon (the area where the mineral melt exits the mineral bath and enters the siphon), and it may be beneficial for the total height of the ceramic support bodies to be above the level of the siphon outlet. This may help to prevent the stack of mineral material from being partially submerged in the mineral melt.

Use of the ceramic support bodies as defined above should aid processability and help ensure suitably sized voids exist between the ceramic support bodies, in which the mineral melt may collect or pool prior to its removal through a melt outlet, such as a siphon. In addition, if the ceramic support bodies are too small then they may exit the furnace through melt outlet together with the mineral melt, or block the melt outlet. If the ceramic support bodies are too large then they may not correctly support the mineral material in the furnace.

In view of the above, the present invention provides an advantageous way of supporting mineral material in a cupola furnace with a substantially reduced amount of coke or even without the use of coke, and is able to prevent unmelted mineral material from exiting the furnace in the melt stream, all without having to modify existing cupola furnaces. This is a substantial benefit over furnaces described in U.S. Pat. No. 5,107,517 and JPH 10141629, which need to be modified to accommodate water-cooled tubes and a cooling system.

As is typical, the process for forming mineral melt may be a continuous process in which mineral melt is continuously removed from the furnace via the melt outlet, with additional mineral material being fed into the furnace through a feed hopper. If the ceramic support bodies degrade during the furnace, additional ceramic support bodies may be added to the furnace with the additional mineral material. As the mineral material melts and is removed from furnace, the additional ceramic support bodies travel down through the furnace until they settle at the bottom of the hot zone. The degradation rate of the ceramic support bodies, and therefore the rate at which they should be added to the furnace with the additional mineral material, may be calculated or derived experimentally by running the furnace for a period of time, allowing the furnace to cool, and inspecting the remaining ceramic support bodies. Additional ceramic support bodies may be added in any suitable amount to maintain their proper function in the furnace. This is typically an amount of from 1 to 5 weight %, more preferably 1 to 2 weight %, based upon the total amount of additional ceramic support bodies and additional mineral material. If the ceramic support bodies have a higher rate of degradation, e.g. if they are of lower quality, then a higher amount will need to be added to the furnace along with the additional mineral material. If the ceramic support bodies have a lower rate of degradation, e.g. if they are of higher quality, then a lower amount will need to be added to the furnace with the additional mineral material.

The furnace is equipped with at least one plasma torch that provides plasma heating in the hot zone. Plasma torches generate thermal plasma using direct current (DC), alternating current (AC), radio-frequency (RF) and other discharges. Thermal plasmas provide heat, which in plasma torches is produced by sending an electric arc between two electrodes, through which arc a carrier gas is passed within a constricted opening. This elevates the temperature of the gas to the point that it enters a fourth state of matter, i.e. plasma. Plasma torches may be transferred or non-transferred. In non-transferred plasma torches, the electrodes are inside the housing of the torch. Whereas in a transferred plasma torch one electrode is located outside the housing of the torch, allowing the arc to form outside of the plasma torch and over a greater distance. It is preferable that the plasma torch in the present invention is a non-transferred plasma torch. Most preferably it is a direct current non-transferred plasma torch.

Plasma torches may use a variety of carrier gases, such as oxygen (O₂), nitrogen (N₂), argon (Ar), helium (He), air, hydrogen (H₂), carbon monoxide (CO), carbon dioxide (CO₂), or mixtures thereof. In the present invention, the carrier gas is preferably selected from the group consisting of N₂, CO, CO₂, or a mixture thereof. It has been found that the production of NOₓ may be significantly reduced when oxygen (O₂) is excluded from zones of a cupola furnace that comprise nitrogen and are at a temperature of 1,400° C. or above. To help minimise the production of NOₓ, the carrier gas, at most, should comprise only a trace amount of oxygen. This means that the carrier gas should comprise less than 5 weight % of oxygen, such as less than 2 weight %, preferably less than 0.8 weight %, based upon the total weight of the carrier gas. Ideally, the carrier gas is devoid of oxygen.

As used herein, and unless otherwise stated, the terms “oxygen”, “nitrogen”, “carbon monoxide”, “carbon dioxide” and “hydrogen” refer to O₂, N₂, CO, CO₂, and H₂, respectively. The term “NOₓ” is known in the art, and includes nitrogen oxides, such as nitric oxide (NO) and nitrogen dioxide (NO₂).

The enthalpy of the carrier gas used in the plasma torch is preferably from 2.0 to 6.0 kWh/Nm³, preferable from 3.0 to 5.0 kWh/Nm³. The enthalpy is calculated as measured power divided by measured carrier gas flow. The enthalpy is relevant for controlling melt temperature and melt capacity.

A cupola furnace useful in the process of the invention may comprise one plasma torch. Alternatively, it may comprise multiple plasma torches, such as two, three, four or more plasma torches. As used herein, reference to “a” or “the” plasma torch means the “one or more plasma torches”. The power of each plasma torch is typically in the region of from 1 to 6 MW.

Notwithstanding the benefits of using a plasma torch to provide thermal energy to a cupola furnace, heat energy may also be provided using alternative means. According to the present invention, greater than 50% of the furnace heating energy is provided by the plasma torch. It may be preferable for a greater amount of the furnace heating to be provided by the plasma torch, such as greater than 60%, preferably greater than 70%, more preferably greater than 80%, even more preferably greater than 90%. Given the advantages of plasma heating, it is preferential that all of the heating energy is provided by the plasma torch. Heat may be provided to the furnace at many locations, however, it is preferable that heating is provided in the hot zone solely by the plasma torch.

If furnace heating is not provide solely by the plasma torch, then the remainder of the heat energy may be provided, for instance, in the traditional way, i.e. by burning fuel, such as natural gas or coke, in a source of oxygen. The oxygen is supplied to the furnace in an oxidation zone that is above the hot zone. The source of oxygen may be provided by any suitable means, such as using at least one tuyere and/or at least one oxygen injection port.

The “source of oxygen” may be from any suitable source, including oxygen gas, air or a combination thereof, i.e. oxygen enriched air. The oxygen provided may oxidise any carbon present in mineral material or coke, as described below.

Tuyeres are typically located at the bottom of the oxidation zone. The cupola furnace may comprise one tuyere, or multiple tuyeres, such as two, three, four, five, six, seven, eight, nine, ten, eleven, twelve, thirteen, fourteen, fifteen, or more tuyeres. When used, it is preferable that there are from nine to thirteen tuyeres, most preferably eleven tuyeres. In this case, it is preferable that the tuyeres are equally distributed around the periphery of the furnace, except at the location of the melt outlet, e.g. melt siphon. In any case, it is preferable that no tuyeres are located in the same zone as the plasma torch, i.e. there are no tuyeres in the hot zone. This helps to avoid oxygen being present in a zone of the cupola furnace that is above 1,400° C.

The tuyeres may provide air at a rate of 70 to 250 Nm³ air per ton charge. The aperture of each tuyere through which air flows into the cupola furnace is typically located from 0 up to a maximum of 1 furnace diameter above the plasma torches. The furnace diameter is the internal diameter of the inner chamber of the cupola furnace.

As tuyeres are typically located around the perimeter of a cupola furnace, they may be unable to supply oxygen to the centre of the furnace that has a large diameter. In this case, at least one oxygen injection port may be present in the furnace to help introduce oxygen into centre of the furnace. As is known in the art, an oxygen injection port may be a tube or pipe that delivers oxygen to the appropriate location in a cupola furnace.

NOₓ may be derived from nitrogen and oxygen under high temperature and pressure. To reduce the formation of NOₓ, the temperature in the oxidation zone of the cupola furnace should be from 600° C. to 1,400° C. To further reduce NOₓ formation, it is preferable that the temperature of the oxidation zone is from 600° C. to 1,300° C., more preferably from 600° C. to 1,200° C., even more preferably from 600° C. to 1,100° C., especially from 600° C. to 1,000° C., most preferably from 600° C. to 900° C., particularly from 600° C. to below 850° C.

The temperature of the hot zone should be greater than the temperature of the oxidation zone. This means that the temperature in the hot zone may be above 800° C., preferably above 900° C., more preferably above 1,000° C., more preferably above 1,100° C., more preferably above 1,200° C., more preferably above 1,300° C. more preferably above 1,400° C.

Based upon the above, the process of the invention may lead to off-gas comprising NOₓ in an amount of less than 400 ppm, preferably less than 300 ppm, more preferably less than 250 ppm, even more preferably less than 200 ppm, more preferably less than 150 ppm. As is understood but the skilled person, ppm of off-gas is ppm by volume. Therefore, any reference to ppm of a gas herein is ppm by volume.

A further unexpected benefit of heating the hot zone with a plasma torch using carrier gas that is, e.g. nitrogen, carbon monoxide, carbon dioxide, or a mixture thereof, is that it may significantly reduce the height of the hot zone in comparison to a corresponding cupola furnace that is heated by means other than a plasma torch.

The use of a plasma torch has yet an additional advantage in that it significantly reduces the response time needed to change the temperature in certain zones of the cupola furnace, and in particular the temperature of the mineral melt. Typically, the mineral melt temperature may be changed within 20 minutes, preferably within 15 minutes, more preferably within 10 minutes when using a plasma torch. This may be a faster temperature change than when other heating means are used.

It has been found that water should be excluded from any zone in the furnace that is at a temperature of above 750° C. This minimises the amount of hydrogen that is formed and is present in the off-gas of the cupola furnace. It is preferable that the furnace produces off-gas comprising hydrogen in an amount of less than 20,000 ppm, preferably less than 10,000 ppm, preferably less than 5,000 ppm, preferably less than 2,000 ppm, preferably less than 1,000 ppm, preferably less than 500 ppm, preferably less than 100 ppm, preferably less than 50 ppm. It is most preferable that there is no detectable amount of hydrogen in the off-gas. As mentioned above, the ppm of off-gas is ppm by volume.

Due to the use of at least one plasma torch, the amount of coke used in the cupola furnace may be significantly reduced, substantially eliminated, or eliminated. To be “significantly reduced”, the amount of coke used may be less than 5 weight %, preferably less than 3 weight %, more preferably less than 2 weight %, based upon the total amount of coke and mineral material. To be “substantially eliminated”, the amount of coke used may be less than 0.5 weight % based upon the total amount of coke and mineral material. Preferably, no coke is added, or coke is present only in trace amounts. In this case, coke is deemed not to be present in the process, i.e. coke is eliminated. It is most preferable that coke is not present in the process.

The combined use of at least one plasma torch and a plurality of ceramic support bodies as described herein means that a mineral melt may be formed in a cupola furnace without the use of coke. This has the advantage of reducing or elimination certain emissions in the off-gas, for instance, producing less CO and/or CO₂ in the off-gas.

The mineral material used to form the mineral melt may comprise carbon. For instance, carbon may be present in recycled mineral material that is used form a mineral melt. Recycled mineral material may be obtained from a range of sources, including waste MMVF. MMVF typically comprises a binder and oil, the type of which is dependent upon the intended use of the MMVF. Binders usually comprise a significate amount of carbon (around 40-70 weight %). Oils may contain carbon up to 90 weight % or more. If a higher proportion of recycled material is used as mineral material, then the amount of CO and CO₂ produced in the process will be higher. As a result, when recycled mineral material is used to form the mineral melt, then it is preferable that the mineral material comprises less than 5 weight % of carbon, preferably less than 2 weight % of carbon, based upon the total weight of the mineral material. This means that the process should produce only low amounts of CO or CO₂.

Notwithstanding the above, mineral material that contains no recycled material may still comprise carbon as impurities. In this case, when the mineral material does not comprise recycled mineral material, then it comprises less than 1 weight % of carbon, preferably less than 0.5 weight % of carbon, based upon the total weight of the mineral material. It is an objective of the invention to reduce the amount of CO and CO₂ produced in the formation of mineral melt, and therefore it is most preferably the mineral material is substantially free from carbon, i.e. only trace amount of carbon is present in the mineral material.

If coke is used in the furnace, or another source of carbon is present in the mineral material, then a source of oxygen should be provided above the hot zone of the cupola furnace, forming an oxidation zone as described above. It may be beneficial for the mineral melt to contain a relatively high amount of Fe2+(in the form of FeO) compared to Fe3+(in the form of Fe₂O₃) or metallic iron. Reduction of iron is typically achieved using a source of carbon, such as coal, coke or other carbonaceous particulate fuel. As it is preferable that carbon is omitted from the present process, reduction of iron may be achieved using metallic aluminium. Metallic aluminium may be in the form of aluminium, such as granular aluminium, or it may be alu-dross. Alu-dross is a particulate waste material from the aluminium processing industry and comprises primarily (usually 50 to 90 wt %) Al₂O₃, with around 0.5 to 10 wt % metallic aluminium.

Aluminium may be added to the mineral material in an amount sufficient to form the required Fe2+/Fe3+ content in the mineral melt. Typically, around 8 to 12 weight % of the mineral material could be alu-dross. It is preferable to use metallic aluminium in the process when the amount of coke used in less than 0.5 wt % based upon the total weight of the coke and mineral material. An additional benefit of using aluminium to reduce iron is that the aluminium is oxidised to Al₂O₃. This is an often required component of a mineral melt.

The off-gas from cupola furnaces that are heated using plasma torches may comprise N₂, CO, CO₂, NOₓ and H₂. The off-gas may comprise additional components, such as water and particles, i.e. solid particles of matter. The off-gas as a whole, or in part, may be used in the carrier gas for one or more of the plasma torches. In this regard, the carrier gas may comprise, or consist of, at least one component of off-gas produced by the furnace. Essentially, the off-gas may be recycled to be used as the carried gas for plasma torched. The components of the off-gas may be separated prior to their use as carrier gas.

The components of the off-gas may be separated from each other, or the combination of two of more components may be separated from the others components. This means that the carrier gas may comprise at least one component of the off-gas, such as one, two, three, four, five, or more components of the off-gas. It is preferable that the carrier gas comprises the off-gas components N₂, CO, CO₂ or a combination thereof. Alternatively, the carrier gas may comprise one off-gas component, such as N₂, CO, or CO₂.

The one or more component of the off-gas may undergo off-gas cleaning prior to its use in the carrier gas. It is preferable that the off-gas cleaning removes particles suspended in the off-gas and/or water. The off-gas cleaning may be carried out on the off-gas as a whole, or at least one component thereof once separated from the remainder of the off-gas.

The carrier gas may consist of the off-gas, or at least one component of the off-gas. Alternatively, it may comprise the off-gas, or at least one component of the off-gas. In the latter case, additional gas that did not form part of the off-gas may be added to the carrier gas prior to its use. In this case, the carrier gas is “topped up” with additional gas.

The mineral melt prepared via the process of the invention may be suitable for the production of MMVF, such as glass fibres or stone fibres. It is preferable that the mineral melt formed is suitable for use to form MMVF. Therefore, in the second aspect of the invention there is provided a process for manufacturing MMVF comprising the steps of
(i) forming a melt using a process as defined herein;
(ii) fiberizing the melt by means of an internal or external spinning process; preferably using a cascade spinner; and
(iii) collecting the formed fibres.

The fibres, particularly MMVF, may be made from the mineral melt in a conventional manner. Generally, they are made by a centrifugal fibre-forming process. For instance, the fibres may be formed by a spinning cup process in which they are thrown outwardly through perforations in a spinning cup, or mineral melt may be thrown off a rotating disc and fibre formation may be promoted by blasting jets of gas through the mineral melt. Fibre formation may be conducted by pouring the mineral melt onto the first rotor in a cascade spinner. In this case, it is preferable that the mineral melt is poured onto the first of a set of two, three, four or even more rotors, each of which rotates about a substantially horizontal axis whereby mineral melt on the first rotor is primarily thrown onto the second (lower) rotor although some may be thrown off the first rotor as fibres, and mineral melt on the second rotor is thrown off as fibres although some may be thrown towards the third (lower) rotor, and so forth. In general, it is preferable that the spinning process uses a cascade spinner.

The properties required of a mineral melt to be used in each spinning method are known to those in the art, and the composition of the mineral melt may be tuned to provide those properties. For instance, those skilled in the art are able to select mineral materials to be added to the cupola furnace to produce a specific mineral melt composition, to be spun by a particular spinning process.

During the fiberizing process, the melt is formed into a cloud of fibres entrained in air and the fibres are collected as a web on a conveyor and carried away from the fiberizing apparatus. The web of fibres is then consolidated, which can involve cross-lapping and/or longitudinal compression and/or vertical compression and/or winding around a mandrel to produce a cylindrical product for pipe insulation. Other consolidation processes may also be performed.

A binder composition is conventionally applied to the fibres, preferably when they are a cloud entrained in air. Alternatively it can be applied after collection on the conveyor, but this is less preferred. Conventional types of binder for use with mineral wool fibres may be used.

After consolidation the consolidated web of fibres is passed into a curing device to cure the binder. The curing may be carried out at temperatures from 100 to 300° C., such as 170 to 270° C., such as 180 to 250° C., such as 190 to 230° C.

It is preferred that the curing takes place in a conventional curing oven for mineral wool production wherein hot air is blown through the consolidated web, preferably operating at a temperature of from 150 to 300° C., such as 170 to 270° C., such as 180 to 250° C., such as 190 to 230° C. The curing may take place for a time of 30 seconds to 20 minutes, such as 1 to 15 minutes, such as 2 to 10 minutes. Typical the curing takes place at a temperature of 150 to 250° C. for a time of 30 seconds to 20 minutes.

The curing process may commence immediately after application of the binder to the fibres. The curing is defined as a process whereby the binder composition undergoes a physical and/or chemical reaction which in case of a chemical reaction usually increases the molecular weight of the compounds in the binder composition and thereby increases the viscosity of the binder composition, usually until the binder composition reaches a solid state. The cured binder composition binds the fibres to form a structurally coherent matrix of fibres.

The curing of the binder in contact with the mineral fibres may alternatively take place in a heat press. The curing of a binder in contact with the mineral fibres in a heat press has the particular advantage that it enables the production of high-density products.

In general, the fibres, and the mineral melt from which they are formed, may have an analysis (measured as weight % of oxides) of elements within the various ranges defined by the following normal and preferred lower and upper limits.

| SiO₂ | 35-50, preferably 38-48, |
|---|---|
| | more preferably 33-44 |
| Al₂O₃ | 12-30, preferably 15-28, |
| | more preferably 16-24 |
| TiO₂ | up to 2 |
| Fe₂O₃ | 2-12 |
| CaO | 5-30, preferably 5-18 |
| MgO | 0-15, preferably 1-8 |
| Na₂O | 0-15 |
| K₂O | 0-15 |
| P₂O₅ | 0-3 |
| MnO | 0-3 |
| B₂O₃ | 0-3. |

It is preferable in this case that, when the melt is to be formed into MMVF, the proportion of Fe(2+) in the mineral melt is greater than 80% based on total Fe, preferably at least 90%, more preferably at least 95% and most preferably at least 97% based on total Fe. In such cases, it is preferable that MMVF is made using a cascade spinner. Further details of these example mineral melts may be found in WO 2012/140173 (which is incorporated herein by reference).

The amount of Fe(2+) and Fe(3+) can be determined using the Mossbauer method described in “The ferric/ferrous ratio in basalt melts at different oxygen pressures”, Helgason et al, Hyperfine Interact., 45 (1989) pp 287-294.

The amount of total iron in the overall melt or fibre composition, based on total oxides in the melt or fibres, is calculated as Fe₂O₃. This is a standard means of quoting the amount of iron present in such an MMVF, a charge or a melt. The actual weight percentage of FeO and Fe₂O₃ present will vary based on the iron oxide ratio and/or redox state of the melt.

In the above example of the mineral melt, and the resulting fibres, it is preferred that the amount of iron in the mineral melt is from 2 to 15% by weight, preferably to 12% by weight. Cupola furnaces tend to have a reducing atmosphere, in particular if any coke is used, which can result in reduction of iron oxides and formation of metallic iron. Preferably, metallic iron is not incorporated into the mineral melt and fibres and should be removed from the furnace. Thus, the conditions in the furnace may be carefully controlled to avoid excess reduction of iron. However, we find that it is possible to produce final product fibres having significant levels of iron oxide.

The process of the invention may be used in the formation of fibres that can be shown to be soluble in physiological saline. Suitable high aluminium, biologically soluble fibres that can advantageously be made using the process of the present invention are described in WO96/14454 and WO96/14274, and others are described in WO97/29057, DE-U-2970027 and WO97/30002 (which are incorporated herein by reference).

Such fibres preferably have an adequate solubility in lung fluids as shown in in vivo tests or in vitro tests, typically conducted in physiological saline buffered to about pH 4.5. Suitable solubilities are described in WO96/14454. Usually the rate of dissolution is at least 10 or 20 nm per day in that saline. The fibres preferably have sintering temperature above 800° C., more preferably above 1,000° C. The melt preferably has a viscosity at fibre forming temperature of 5 to 100 poise, preferably 10 to 70 poise at 1,400° C. Additional embodiments of this example may be found in WO 99/28252 (which is incorporated herein by reference).

Preferably, the mineral melt in this particular example has a viscosity in the range 10 to 30 poises at 1400° C., more preferably in the range 15 to 25 poises. An advantage of choosing these viscosities is that the resulting MMVF have a smaller diameter than if the viscosity of the melt were higher. Further, it is possible to use the melt at a lower temperature in order to achieve the required operating viscosities. This saves energy, as it is possible to use the melt at a lower temperature. It also reduces the wear on rotors used to produce fibers, as a lower temperature melt causes less wear. Further details of this example mineral melt may be found in WO 2015/055758 (which is incorporated herein by reference). The viscosity of the melt may be determined in accordance with ASTM C 965-96.

A cupola furnace useful in the process of the invention may comprise the components and zones described above, in addition to the following. Usually the mineral melt forms a pool in the hot zone, from which it is run off via a melt outlet, such as a melt siphon, to a fibre forming process. The mineral melt may be run from the base of the cupola furnace into another chamber where it collects as a pool and from which it is run off to a fibre-forming process.

The raw materials (mineral material) may be in the form of briquettes. Briquettes are made in a known manner by moulding a mix of the desired particulate materials and a binder into the desired briquette shape and curing the binder.

The binder may be a hydraulic binder, i.e. one that is activated by water, for instance Portland cement. Other hydraulic binders can be used as partial or complete replacement for the cement and examples include lime, blast furnace slag powder, and certain other slags, and even cement kiln dust and ground MMVF shot (JP-A-51075711, U.S. Pat. Nos. 4,662,941 and 4,724,295 each of which is are incorporated herein by reference). Alternative binders include clay. The briquettes may also be formed with an organic binder such as molasses, for instance as described in WO 95/34514 (which is included herein by reference). Such briquettes may be described as formstones.

The MMVF may be formed as a bonded web comprising the MMVF as described above, or MMVF made according to the process described above, and a cured binder composition.

The melt formed according to the process of the invention, and man-made fibres (preferably MMVF) made therefrom, may be suitable for use in a range of products, such as insulating elements (both thermal and/or acoustic), and fire insulation elements, as well as plant growth substrates.

According to the third aspect of the invention there is provided the use of ceramic support bodies in a cupola furnace to
(A) support mineral material, and reduce the amount of coke, required to produce a mineral melt suitable for the manufacture of MMVF; and/or
(B) increase the thermal efficiency when superheating a mineral melt suitable for the manufacture of MMVF.

The use may be as defined in the above-mentioned process.

The invention will be described in further detail with reference to the drawing which shows a furnace for carrying out the process according to the invention.

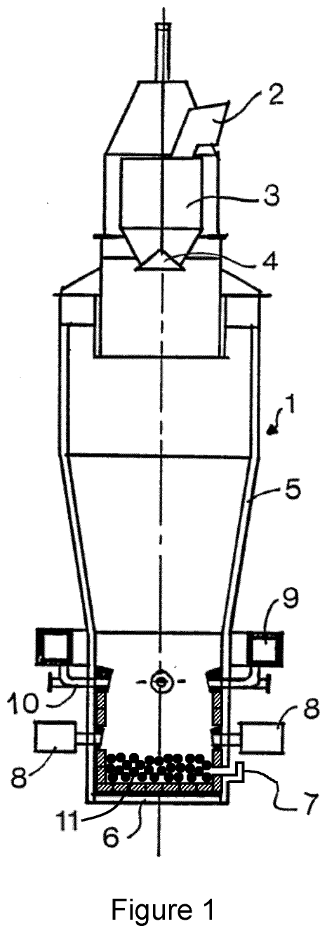

The drawing in FIG. 1 shows a cupola furnace 1 having a feed hopper 2 which communicates with a vessel 3 having a bottom that is constituted by an axially displaceable cone 4. Below the vessel 3 there is a melting chamber which is enclosed by a water-cooled jacket 5. The cupola furnace 1 comprises at its lower end a plane furnace bottom 6 and in a suitable distance above the bottom 6 there is provided a melt outlet, such as a melt siphon 7. A number of plasma torches 8 are built into the furnace wall some distance above the level wherein the melt outlet 7 is placed. If a source of oxygen is required in the furnace, then at a higher level there is provided an annular oxygen inlet pipe 9 which communicates with a number of tuyeres 10 and/or a number of oxygen injection ports (not shown). The cupola furnace 1 has an inner lining at the hot zone, which is made from bricks. The lining covers the furnace bottom 6 and the inner furnace wall to a height at least up to the tuyeres 10. A plurality of ceramic support bodies 11 are located in a section of the hot zone in which the mineral melt collects prior to the mineral melt being removed from the furnace.

The mineral material, i.e. the raw materials, having a composition corresponding to that of the desired melt are fed into the melting chamber through the hopper 2 and the vessel 3, the dosage being effected by suitable adjustment of the cone 4. If carbonaceous material, such as coke, is required then it may be added with the mineral material.

The upper portion of the melting chamber acts as preheating zone as the materials are heated by the ascending smoke gases. From the preheating zone the materials descend down through the furnace, and through the oxidation zone, if present. The lower limit of the oxidation zone is located at the level where oxygen is introduced through the tuyeres 10 and/or oxygen injection port(s). If an amount of coke is used, then it is combusted in the oxidation zone so as to form CO₂. The temperature in the oxidation zone is kept at such a level that the temperature of the portion of the preheating zone located immediately above the upper end of the oxidation zone does not exceed 1000° C. so as to eliminate or considerably reduce a reaction between the CO₂ formed in the oxidation zone and carbon so as to form CO. The actual melting is effected in the portion of the melting chamber which is located below the oxidation zone and wherein strong heat is introduced by means of the plasma torches 8. During the melting process, the mineral material is supported by the ceramic support bodies 11. The melt formed descends down towards the bottom of the furnace where it collects (or pools) in voids between the ceramic support bodies 11. The melt is discharged through the melt outlet 7.

### EXAMPLES

The invention is further illustrated by the following non-limiting examples.

A mineral melt was formed in a plasma fired cupola furnace, in which the plasma torches are provided with N₂ as the carrier gas. The furnace was equipped with ceramic bodies and no coke was added. The oxidation state of the iron in the melt was adjusted by incorporating 10 weight % of Serox W (Alu-dros) (approximately 2 weight % of metallic aluminium) in the mineral charge. The mineral material used in the furnace was briquettes containing recycled mineral wool waste which accounts for the presence of CO and CO₂ in the off-gas. The table below compares the parameters and results from the furnace with the ceramic support bodies (column A) to a theoretical furnace that does not contain ceramic support bodies and in which coke is added with the mineral material (column B).

| | A | B |
|---|---|---|
| Plasma torch | | |
| power, kwh/(ton raw material) | 1100 | 980 |
| carrier N₂ flow, Nm³/ | 262 | 245 |
| (ton raw material) | | |
| enthalpy, kwh/Nm³ | 4.2 | 4.0 |
| Coke | | |
| kwh/(ton raw material) | 0 | 215 |
| Ceramic Support Bodies | | |
| kg/(ton raw material) | 15 | 0 |
| Air to tuyere, | | |
| Nm³/(ton raw material) | 80 | 177 |
| Off-gas chemical compositions | | |
| CO % by volume | 0.5 | 2.4 |
| CO₂% by volume | 5.5 | 7.2 |
| H₂% by volume | 0.8 | 0.9 |
| O₂% by volume | 3.5 | 1.2 |

The data show that the amount of CO and CO₂ in the off-gas is significantly reduced when using the ceramic support bodies with no coke. The amount of CO and CO₂ formed in column A may be considered a baseline amount, as it is indicative of the amount of carbon that is present in the briquettes containing recycled mineral wool waste (up to 50% milled mineral wool waste) used in the furnace.

1. A process for preparing a mineral melt in a cupola furnace, wherein the cupola furnace comprises a hot zone at the base of the furnace, and a melt outlet in the hot zone,
(i) the furnace comprises at least one plasma torch that provides plasma heating in the hot zone;
(ii) greater than 50% of the furnace heating energy is provided by the at least one plasma torch;
(iii) the furnace comprises a plurality of ceramic support bodies located in a section of the hot zone in which the mineral melt collects prior to the mineral melt being removed from the furnace through the melt outlet,
wherein mineral material supplied to the furnace is melted to form the mineral melt that collects in voids between the ceramic supports bodies.

2. The process according to claim 1, wherein:
(I) greater than 60%, preferably greater than 70%, more preferably greater than 80%, event more preferably greater than 90%, most preferably all, of the cupola furnace heating energy is provided by the at least one plasma torch; and/or
(II) wherein heating is provided in the hot zone solely by the at least one plasma torch.

3. The process according to claim 1, wherein the cupola furnace comprises an oxidation zone above the hot zone, and wherein a source of oxygen is provided in the oxidation zone, preferably using at least one tuyere and/or at least one oxygen injection port, and
wherein the temperature in the oxidation zone is from 600° C. to 1,400° C., preferably from 600° C. to 1,300° C., more preferably from 600° C. to 1,200° C., even more preferably from 600° C. to 1,100° C., especially from 600° C. to 1,000° C., most preferably from 600° C. to 900° C., particularly from 600° C. to below 850° C.

4. The process according to claim 1, wherein:
(a) the temperature in the hot zone is above 800° C., preferably above 900° C., more preferably above 1,000° C., more preferably above 1,100° C., more preferably above 1,200° C., more preferably above 1,300° C., more preferably above 1,400° C.; and/or
(b) water is substantially excluded from any zone of the furnace where the temperature is above 750° C.

5. The process according to claim 1, wherein the plurality of ceramic support bodies:
(A) have a melting temperature of at least 1,400° C., preferably at least 1,600° C., more preferably at least 1,800° C.; and/or
(B) are resistant to chemical degradation in the cupola furnace during the process.

6. The process according to claim 1, wherein each ceramic support body comprises Cr₂O₃ in an amount of at least 5 weight %, and/or ZrO₂ in an amount of at least 5 weight %, based upon the total weight of the ceramic support body.

7. The process according to claim 1, wherein the plurality of ceramic support bodies:
(I) have an equivalent spherical diameter of from 60 mm to 250 mm, preferably from 70 mm to 200 mm, more preferably from 80 mm to 150 mm, most preferably from 90 mm to 110 mm; and/or
(II) the ceramic support bodies are ball-shaped.

8. The process according to claim 1, wherein the process is a continuous process, and additional ceramic support bodies and additional mineral material are added to the cupola furnace, preferably wherein the additional ceramic support bodies are added in an amount of from 1 to 5 weight %, more preferably 1 to 2 weight %, based upon the total amount of additional ceramic support bodies and additional mineral material.

9. The process according to claim 1, wherein the at least one plasma torch uses, as carrier gas, nitrogen, carbon monoxide, carbon dioxide, or a mixture thereof, preferably wherein the carrier gas enthalpy is from 2.0 to 6.0 kWh/Nm³, more preferable from 3.0 to 5.0 kWh/Nm³.

10. The process according to claim 1, wherein the mineral melt has the following composition expressed as oxides, by weight %
SiO₂ 35-50, preferably 38-48, more preferably 33-44
Al₂O₃ 12-30, preferably 15-28, more preferably 16-24
TiO₂ up to 2
Fe₂O₃ 2-12
CaO 5-30, preferably 5-18
MgO 0-15, preferably 1-8
Na₂O 0-15
K₂O 0-15
P₂O₅ 0-3
MnO 0-3
B₂O₃ 0-3,
preferably wherein the proportion of Fe(2+) in the melt is greater than 80% based on total Fe, preferably at least 90%, more preferably at least 95% and most preferably at least 97% based on total Fe.

11. The process s according to claim 1, wherein the mineral material comprises metallic aluminium that reduces the oxidation state of iron.

12. The process according to claim 1, wherein:
(a) oxygen (O₂) is excluded from zones of the cupola furnace that comprise nitrogen and are at a temperature of 1,400° C. or above, such that the furnace produces off-gas comprising NOₓ in an amount of less than 400 ppm by volume, preferably less than 300 ppm by volume, more preferably less than 250 ppm by volume, even more preferably less than 200 ppm by volume, more preferably less than 150 ppm by volume; and/or
(b) water is excluded from any zone in the furnace that is at a temperature of above 750° C. such that the furnace produces off-gas comprising hydrogen in an amount of less than 20,000 ppm by volume, preferably less than 10,000 ppm by volume, preferably less than 5,000 ppm by volume, preferably less than 2,000 ppm by volume, preferably less than 1,000 ppm by volume, preferably less than 500 ppm by volume, preferably less than 100 ppm by volume, preferably less than 50 ppm by volume, most preferably there is no detectable amount of hydrogen in the off-gas.

13. The process ° according to claim 1, wherein the at least one plasma torch uses carrier gas, and the carrier gas comprises, or consists of, at least one component of off-gas produced by the furnace, preferably wherein the at least one component of the off-gas undergoes off-gas cleaning prior to its use as carrier gas, more preferably the off-gas cleaning is to remove particles and/or water.

14. The process according to claim 1, wherein:
(i) when the mineral material comprises recycled mineral material, such as waste man-made vitreous fibre, then it comprises less than 5 weight % of carbon, preferably less than 2 weight % of carbon, based upon the total weight of the mineral material; or
(ii) when the mineral material does not comprise recycled mineral material, such as waste man-made vitreous fibre, then it comprises less than 1 weight % of carbon, preferably less than 0.5 weight % of carbon, based upon the total weight of the mineral material, and most preferably the mineral material is substantially free from carbon.

15. A process for manufacturing man-made vitreous fibre (MMVF) comprising the steps of:
(i) forming a melt using the process according to claim 1;
(ii) fiberizing the melt by means of an internal or external spinning process; preferably using a cascade spinner; and
(iii) collecting the formed fibres.
